(19) United States
(12) Patent Application Publication
(10) Pub. No.: US 2025/0181280 A1
(43) Pub. Date: Jun. 5, 2025

(54) PRINTING SYSTEM, STORAGE MEDIUM, AND METHOD

(71) Applicant: CANON KABUSHIKI KAISHA, Tokyo (JP)

(72) Inventor: MITSUO KIMURA, Kanagawa (JP)

(21) Appl. No.: 18/963,316

(22) Filed: Nov. 27, 2024

(30) Foreign Application Priority Data
Nov. 30, 2023 (JP) 2023-202364

(51) Int. Cl. G06F 3/12

(52) U.S. Cl. CPC G06F 3/1204; G06F 3/1267; G06F 3/1288

(57) ABSTRACT

There is provided a printing system that attaches a file name different from the file name in the storage to document data acquired from a storage and stores the document data. When generating intermediate data based on the document data stored in the storage unit in a case where the document data includes a file name field where a file name is to be output, the printing system generates the intermediate data in a state such that a file name based on the file name in the storage is to be output to the file name field, and generates print data print-executable with a printer, by using the generated intermediate data.

### BACKGROUND

### Field of the Disclosure

The present disclosure relates to a printing system, a storage medium, and a method for generating print data based on document data.

### Description of the Related Art

A certain cloud print service provides print data of document data stored in a cloud storage, such as Google® Drive and One Drive®. The cloud print service using a cloud server acquires specified document data from a cloud storage in response to a request from a client terminal, such as a smart phone, converts the acquired document data into print data, and provides a printer with the print data.

In a case where a cloud server providing such print services acquires a file from the cloud storage and temporarily stores the file in the cloud server, the cloud server typically changes the name of the acquired file to a file name easy to be handled in the cloud server to store the file. More specifically, the cloud server attaches a file name different from the file name used in the cloud storage to the acquired file to store the file.

The cloud server and the cloud storage may use different operating systems (OS's), and characters and the number of characters that can be used for a file name also depend on each OS. The above-described processing is therefor intended to prevent an error due to a file name when handling a file generated by a different OS. For OS-dependent characters, some predetermined characters are not usable, for example, “\”, “/”, “:”, “*”, “?”, “″”, “<”, “>”, and “|” in a case of Windows® OS. The cloud server (e.g., a server for providing print services) having acquired a file unifies the file name format in the cloud server, thereby providing an effect of facilitating file management. In a cloud server of print services, there is a case where a job identifier to be returned in response to a print request from a client is used as a file name of document data. In this case, the client specifies the job identifier when requesting the print service to cancel printing or perform printing again. Since the print service needs to read or delete a file having a file name conforming to the job identifier, it is easy to identify a processing target file by attaching the job identifier to the file.

Japanese Patent Application Laid-Open No. 2003-271431 discusses a technique for converting a user-input character string into a file name composed only of limited characters usable by a different OS. By applying the technique discussed in Japanese Patent Application Laid-Open No. 2003-271431 to a cloud server providing print services, the file name of document data acquired from a cloud storage can be composed only of characters usable by the cloud server. However, also in this case, the file name of the document data when stored in the cloud storage is different from the file name of the document data to be temporarily stored in the cloud server for providing print services.

Depending on a document data format, a field (file name field) to be updated with the file name at the printing time can be placed in the document. For example, in a case of document data in the MS Word format, a file name field can be arranged in the header/footer portion of the document. The MS Word format refers to a document data format used in the Word software from Microsoft Corporation®. When document data having in which the file name field is set is printed, the character string of the file name is output to the position of the file name field in the print result. In a case where document data in the MS Word format is converted to Portable Document Format (PDF) by using a PDF conversion driver (e.g., Microsoft®'s print to PDF), the character string of the file name is output to the position of the file name field in the PDF file after the conversion.

When a cloud server providing print services performs processing for generating print data based on document data on which the file name field is placed, the character string of the file name of the document data when temporarily stored in the cloud server will be output to the position of the file name field in the relevant print data. As described above, the file name when the document data is stored in the cloud storage is different from the file name when the document data is temporarily stored in the cloud server providing print services. Thus, the character string output to the file name field of the print data is different from the character string when the print data is stored in the cloud storage. In other words, the character string output to the file name field of the print data is the file name when the data is temporarily stored in the cloud server for providing print services. Since the user selects the document data stored in the cloud storage as a printing target, the user expects that the file name of the document data on the cloud storage is printed. However, there has been an issue that the relevant file name is not output.

### SUMMARY

According to embodiments of the present disclosure, a printing system acquires document data stored in a storage and generates print data of the acquired document data. The printing system attaches a file name different from a file name in the storage to the document data acquired from the storage and storing the document data in a storage unit of the printing system, generates, in a case where the document data includes a file name field where a file name is to be output, when generating intermediate data based on the document data stored in the storage unit, the intermediate data in a state such that a file name based on the file name in the storage is to be output to the file name field, and generates print data print-executable with a printer by using the generated intermediate data.

Further features of the present disclosure will become apparent from the following description of exemplary embodiments with reference to the attached drawings.

### BRIEF DESCRIPTION OF THE DRAWINGS

FIG. 1 illustrates an overall configuration of a printing system for providing print services.

FIGS. 2A and 2B illustrate examples of hardware configurations of the print service.

FIGS. 3A to 3D illustrate an example of a software configuration of the print service.

FIG. 4 illustrates examples of document data and a print result.

FIG. 5 illustrates screens displayed when a print instruction is issued on a mobile terminal.

FIG. 6 illustrates a processing flow according to a first exemplary embodiment.

FIG. 7 is a flowchart illustrating processing according to the first exemplary embodiment.

FIG. 8 is a flowchart illustrating processing according to a second exemplary embodiment.

FIG. 9 is a flowchart illustrating processing according to a third exemplary embodiment.

### DESCRIPTION OF THE EMBODIMENTS

Exemplary embodiments of the present disclosure will be described below with reference to the accompanying drawings. The following exemplary embodiments do not limit the present disclosure. Not all of the configurations described in the exemplary embodiments are indispensable to the solutions for issues of the present disclosure.

### <System Configuration>

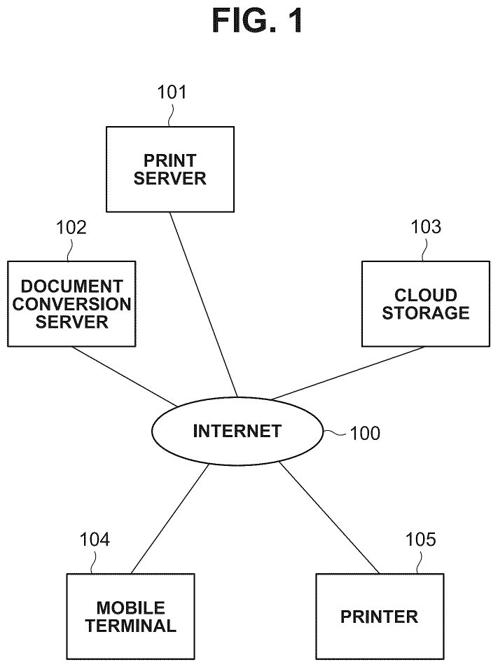

FIG. 1 illustrates an overall configuration of a printing system for providing print services according to a first exemplary embodiment. Referring to FIG. 1, the printing system according to embodiments of the present disclosure includes a print server 101 and a document conversion server 102. The print server 101 generates print data based on document data stored in a cloud storage 103 in collaboration with the document conversion server 102, and further provides a printer 105 with the generated print data. In response to a request from a client terminal such as a mobile terminal 104, the print server 101 acquires the requested document data from the cloud storage 103 and generates print data. The file format of this document data is, for example, the MS Word format. The generated print data can be interpreted and printed by the printer 105.

The document conversion server 102 has a function of generating intermediate data interpretable by the print server 101 based on the document data, in response to a request from the print server 101. According to the present exemplary embodiment, the intermediate data is the PDF format. The document conversion server 102 generates a PDF file based on document data in the MS Word format by using the export function of the Microsoft® Word software. More specifically, the print server 101 according to the present exemplary embodiment acquires the document data requested by the client terminal, from the cloud storage 103, transmits the acquired document data to the document conversion server 102 to generate intermediate data, and converts the generated intermediate data into print data.

The cloud storage 103 stores document data. The OS used by the cloud storage 103 is different from the OS's of the print server 101 and the document conversion server 102. Character strings unusable for a file name by the print server 101 and the document conversion server 102 can be used for a file name by the OS of the cloud storage 103. Although the present exemplary embodiment will be described below centering on a case where the document data stored in the cloud storage 103 is selected as a printing target, the storage source of the document data is not limited to the cloud storage 103 but may be other storages, such as a file server. In other words, document data that may be a print target is to be stored in a state of being attached with the original file name in the cloud storage 103 or the file server.

The mobile terminal 104, such as a smart phone, is a type of a client terminal. The user requests, with the mobile terminal 104, the print server 101 to print the document data stored in the cloud storage 103. The client terminal 104 is not limited to the mobile terminal 103 but may be a common personal computer (PC).

The printer 105 acquires the print data generated by the print server 101 to print the print data. The print server 101, the cloud storage 103, the mobile terminal 104, and the printer 105 are connected via the Internet 100.

### <Hardware Configuration>

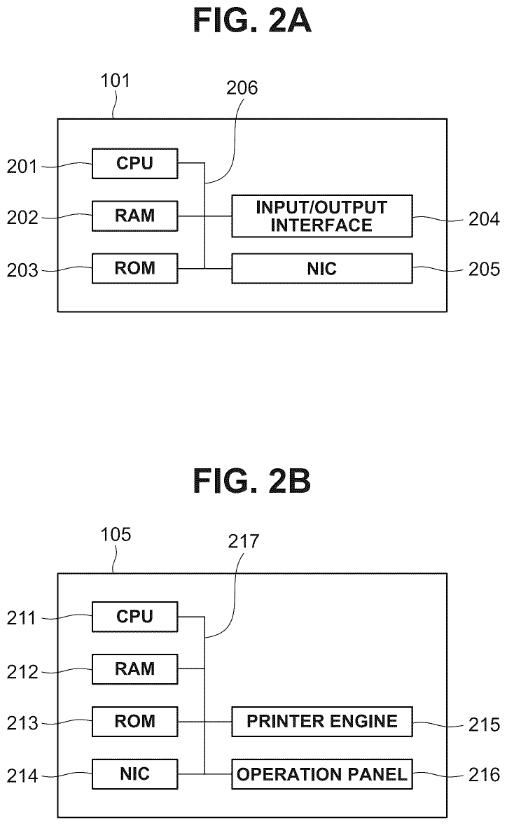

FIG. 2A is a block diagram illustrating a basic hardware configuration of an apparatus usable as the print server 101, the document conversion server 102, or the mobile terminal (client terminal) 104.

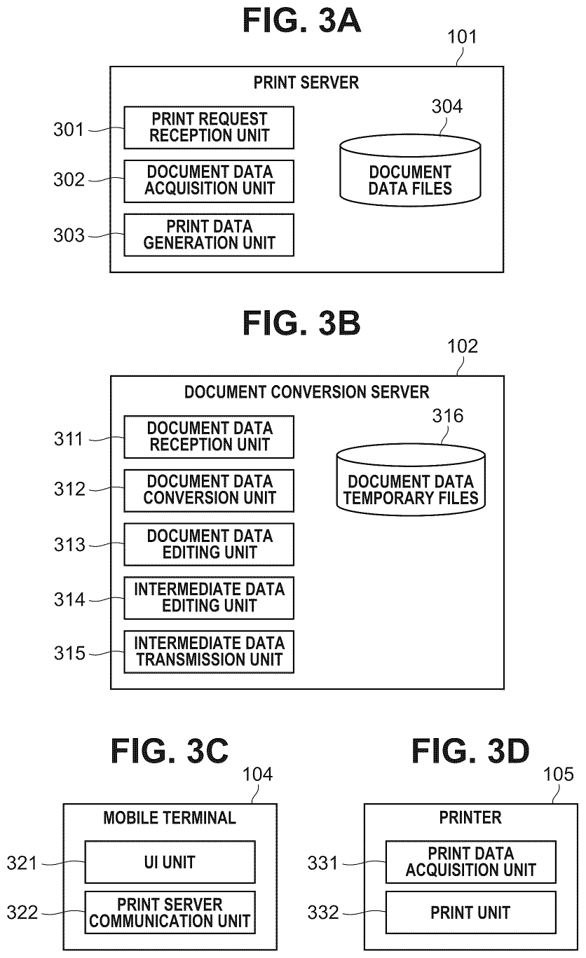

Referring to FIG. 2A, a central processing unit (CPU) 201 executes various programs to implement diverse functions. A random access memory (RAM) 202 is a unit for storing various information. The RAM 202 is also used as a temporary working memory area for the CPU 201. A read only memory (ROM) 203 is a unit for storing various programs. For example, the CPU 201 loads a program stored in the ROM 203 into the RAM 202 to execute the program. The CPU 201 may perform processing based on programs stored in an external storage apparatus, such as a flash memory, a hard disk drive (HDD), or a solid state disk (SSD). The print server 101, the document conversion server 102, and the mobile terminal 104 execute respective apparatus programs to function as software components illustrated in FIGS. 3A to 3D (described below) and perform processing of each step of a sequence (described below).

The functions of the print server 101, the document conversion server 102, and the mobile terminal 104 and processing for the sequence to be described below are not limited to processing implemented by executing programs. All or a part of the processing may be implemented by using dedicated hardware.

An input/output interface 204 is a unit for providing interfaces with output apparatuses such as a display apparatus and input apparatuses such as a keyboard and mouse. Alternatively, the input/output interface 204 is an input/output apparatus such as a touch panel. A network interface card (NIC) 205 is a unit for connecting the print server 101, the document conversion server 102, and the mobile terminal 104 with a network such as the Internet 100 and a local area network (LAN). The above-described units 201 to 205 are configured to perform data transmission and reception via a bus 206.

FIG. 2B is a block diagram illustrating a basic hardware configuration of the printer 105.

A CPU 211, a RAM 212, a ROM 213, and a NIC 214 in FIG. 2B are similar to the CPU 201, the RAM 202, the ROM 203, and the NIC 205 in FIG. 2A, respectively, and thus redundant descriptions thereof will be omitted. However, the CPU 211 of the printer 105 executes a printer control program to implement a function and processing to be described below. A printer engine 215 is an output unit for printing the print data. An operation panel 216 is an input unit for receiving operations from the user. The above-described units 211 to 216 are configured to perform data transmission and reception via a bus 217.

### <Software Configuration>

A software configuration will now be described below in which the print server 101, the document conversion server 102, the mobile terminal 104, and the printer 105 execute respective apparatus programs to function as processing units.

FIG. 3A illustrates a software configuration of the print server 101. A print request reception unit 301 of the print server 101 receives a print request from the mobile terminal 104 via the NIC 205. A document data acquisition unit 302 acquires document data from the cloud storage 103. A print data generation unit 303 performs processing for generating print data based on the document data. The document data acquired from the cloud storage 103 and the print data generated based the document data are stored as document data files 304 in the RAM 202 of the print server 101. When the printer 105 completes printing, the document data generation unit 303 deletes these pieces of data.

FIG. 3B illustrates a software configuration of the document conversion server 102. A document data reception unit 311 of the document conversion server 102 receives document data from the print server 101 via the NIC 205. A document data conversion unit (intermediate data generation unit) 312 has a function of generating intermediate data having a format processable by the print server 101, based on the received document data. A document data editing unit 313 has a function of editing document data. An intermediate data editing unit 314 has a function of editing intermediate data. An intermediate data transmission unit 315 transmits converted intermediate data to the print server 101. The intermediate data transmission unit 315 stores document data received from the print server 101 and generated intermediate data in the RAM of the document conversion server 102 as a document data temporary file 316. After transmitting the intermediate data to the print server 101, the intermediate data transmission unit 315 deletes these pieces of data.

FIG. 3C illustrates a software configuration of the mobile terminal 104. The mobile terminal 104 includes a user interface (UI) unit 321 for receiving a user input from the user via an Input/Output interface 204, and a print server communication unit 322 for communicating with the print server 101.

FIG. 3D illustrates a software configuration of the printer 105. The printer 105 includes a print data acquisition unit 331 for acquiring print data from the print server 101 via a NIC 217, and a print unit 332 for printing the acquired print data.

### <Processing Flow>

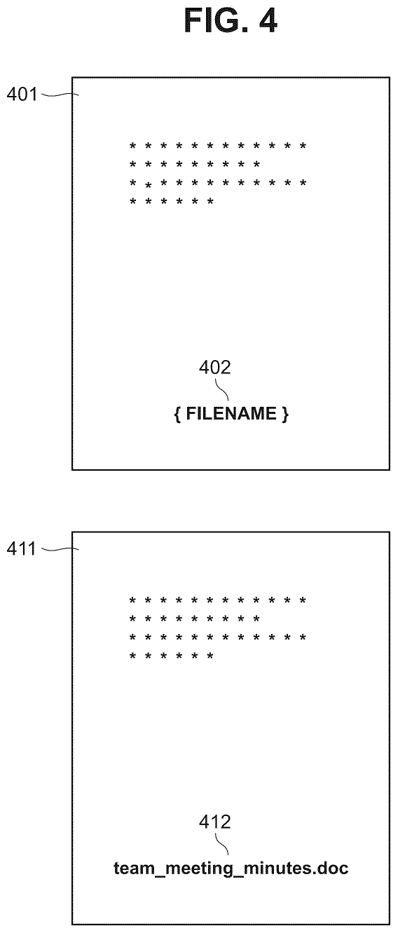

FIG. 4 illustrates an example of document data 401 in which a file name field 402 is placed in the document footer area. In the document data, texts and drawings (not illustrated) are to be placed in the body of the document. FIG. 4 also illustrates an example of document data 411 in which a file name character string 412 is output to the file name field 402 when print data is generated based on the document data 401. More specifically, the document data 411 indicates a result of printing the print data generated based on the document data 401 or a result of converting the document data 401 into another file format (e.g., PDF format). The file name character string 412 indicates an example of a result of outputting to the file name field 402. In a case where the document data 401 is stored under the file name “team_meeting_minutes.doc” is printed or converted into another file format, the file name character string is output to the position of the file name field 402.

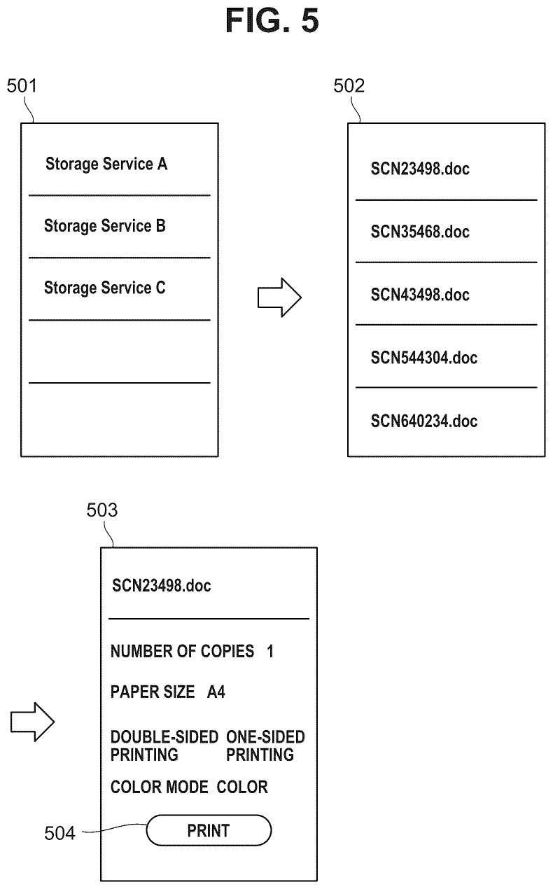

FIG. 5 illustrates examples of screens displayed on the mobile terminal 104 when the mobile terminal 104 selects the document data stored in the cloud storage 103 based on a user instruction and issues a print instruction. The mobile terminal 104 displays a cloud storage lists display screen 501 displaying a list of cloud storages accessible via the print server 101. When the user selects a desired cloud storage in the displayed screen 501, a screen 502 appears. The screen 502 is a document data list display screen displaying a list of document data stored in the selected cloud storage. The document data list may be acquired when the mobile terminal 104 accesses the cloud storage 103 directly or via the print server 101. When the user selects desired document data in the screen 502, a print instruction screen 503 for issuing an instruction for printing the selected document data appears. In the screen 503, the user sets various print settings, such as the number of copies and paper size, and presses a print button 504. The mobile terminal 104 then transmits a print request to the print server 101.

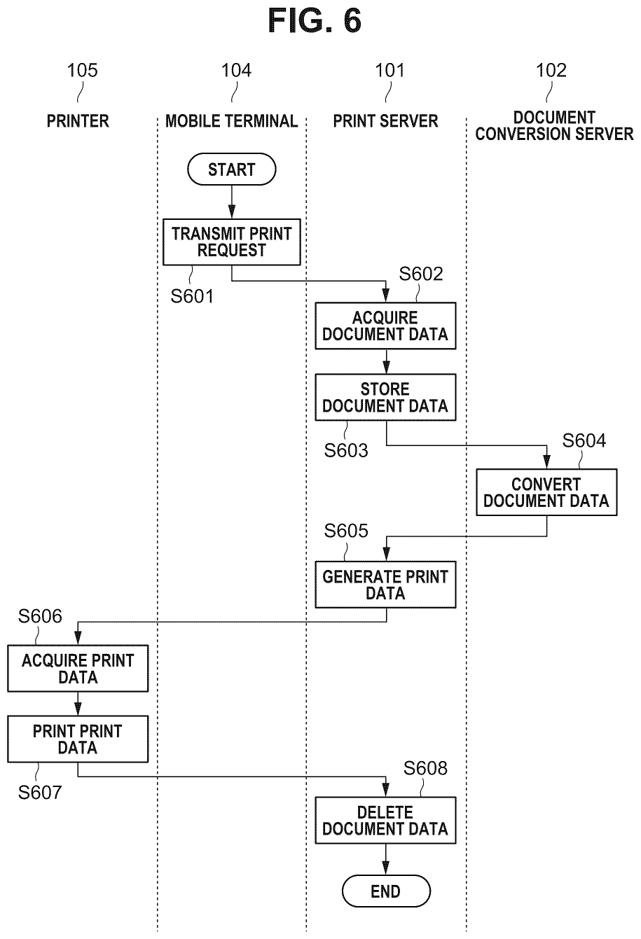

The processing flow in FIG. 6 starts when the user presses the print button 504 in the print instruction screen 503 displayed on the mobile terminal 104. In step S601, the print server communication unit 322 of the mobile terminal 104 transmits the print request for the selected document data to the print server 101.

In step S602, when the print request reception unit 301 of the print server 101 receives the print request, the document data acquisition unit 302 acquires the user-selected document data and its file name (the file name in the cloud storage 103) from the cloud storage 103. In step S603, the print server 101 stores the document data as the document data file 304. At this time, the file name of the document data file 304 stored in the print server 101 includes a unique job identifier suitable for the management by the print server 101. The print server 101 then transmits the document data and information about the file name in the cloud storage 103 to the document data conversion server 102. More specifically, since the document data to be transmitted from the print server 101 to the document data conversion server 102 is attached with a file name suitable for the management by the print server 101, the printer server 101 transmits the information about the file name in the cloud storage 103 as well as the document data.

In step S604, the document data reception unit 311 of the document conversion server 102 receives the document data and the information about the file name in the cloud storage 103. The document data conversion unit 312 then converts the document data into intermediate data in another format (e.g., PDF) interpretable by the print server 101, based on the document data and the information about the file name in the cloud storage 103. The intermediate data transmission unit 315 of the document conversion server 102 transmits the converted intermediate data to the print server 101.

In step S605, the print server 101 receives the intermediate data, and the print data generation unit 303 of the print server 101 converts the received intermediate data into print data. The print server 101 stores the print data after the conversion in association with the document data stored in step S603.

In step S606, the print data acquisition unit 331 of the printer 105 acquires the print data from the print server 101. At this time, in response to a request from the print data acquisition unit 331 of the printer 105, the print server 101 transmits the print data corresponding to the requested document data.

In step S607, the print unit 332 of the printer 105 prints the acquired print data. When printing is successfully completed, the printer 105 notifies the print server 101 of successful printing. In step S608, the print server 101 deletes the document data file generated in step S603 and the print data generated in step S605. The processing then exits the flowchart.

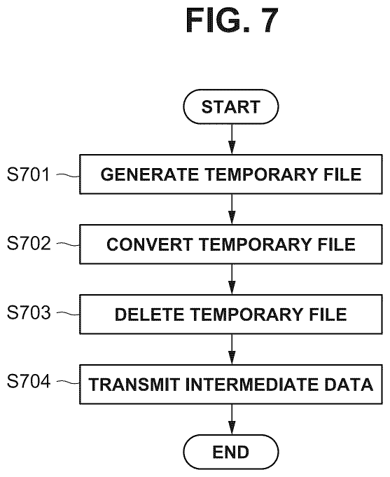

FIG. 7 is a flowchart illustrating detailed processing in step S604 in FIG. 6 performed by the document conversion server 102 to generate intermediate data based on the document data.

In step S701, the document data reception unit 311 of the document conversion server 102 stores the document data received from the print server 101, as the document data temporary file 316. At this time, the document data reception unit 311 stores the name of the document data temporary file 316 by using the information about the file name in the cloud storage 103 received from the print server 101. However, if the file name in the cloud storage 103 includes a character unusable for a file name under the OS of the document conversion server 102, the document data reception unit 311 replaces the character with a character usable for a file name and stores the character string after the replacement as the file name of the document data temporary file 316. The present exemplary embodiment assumes that the OS of the document conversion server 102 is Windows® and therefore a character unusable for a file name under Windows® is replaced with an underscore. Accordingly, the file name of the document data temporary file 316 is the file name in the cloud storage 103 or a file name conforming to the file name in the cloud storage 103 (some characters are replaced with an underscore).

In step S702, the document data conversion unit 312 generates intermediate data based on the document data temporary file 316. At this time, the file name of the document data temporary file 316 is output to the position of the file name field of the generated intermediate data. Since the file name of the document data temporary file 316 is the file name in the cloud storage 103 or a file name conforming to the file name in the cloud storage 103, the relevant file name is output to the file name field.

In step S703, the document data conversion unit 312 deletes the document data temporary file 316. In step S704, the intermediate data transmission unit 315 transmits the generated intermediate data to the print server 101. The processing exits then the flowchart.

Although, according to the present exemplary embodiment, the document conversion server 102 converts document data into intermediate data by using the Microsoft® Word software, the present disclosure is not limited to this configuration. For example, the present exemplary embodiment may be configured to perform the conversion by using an external cloud service (e.g., Microsoft® Graph API) instead of the document conversion server 102. Even in this case, the present exemplary embodiment transmits the information about the file name in the cloud storage 103 together with the document data to the external cloud service to issue an instruction for storing the document data under the relevant file name.

As described above, the document conversion server 102 temporarily stores document data with the same file name as the file name in the cloud storage 103 or a guessable file name, and converts the temporarily stored document data file into intermediate data. The print server 101 converts the intermediate data in which the file name of the document data temporary file 316 is output to the file name field, into print data. The file name in the cloud storage 103 or a guessable file name is therefore output to the file name field of the generated print data.

The file name in the cloud storage 103 or a file name conforming to the file name in the cloud storage 103 is thus printed in the document printed by the printer 105, thereby allowing the user to use the printed document without a feeling of strangeness. The print server 101 also stores the generated print data in association with the document data attached with a file name suitable for the management in the print server 101, thereby facilitating the management of the print data.

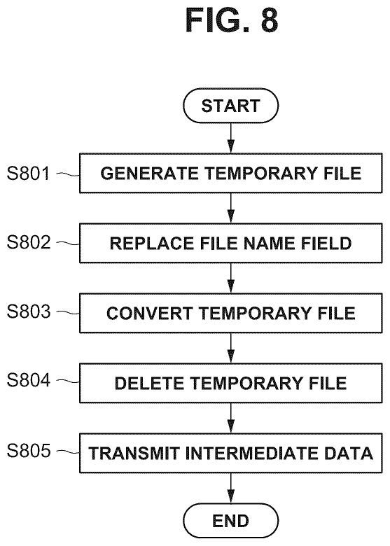

A second exemplary embodiment will now be described centering only on differences from the first exemplary embodiment. FIG. 8 is a flowchart illustrating detailed processing according to the second exemplary embodiment for generating intermediate data based on the document data in step S604 in FIG. 6.

In step S801, the document data reception unit 311 of the document conversion server 102 stores, as the document data temporary file 316, the document data received from the print server 101. At this time, the file name attached by the print server 101 is directly used as the file name of the document data temporary file 316. Alternatively, a file name suitable for the management in the document conversion server 102 is newly attached to the relevant file.

In step S802, the document data editing unit 313 of the document conversion server 102 deletes the file name field described in the document data temporary file 316, and instead, inserts the character string “File Name in Cloud Storage” received from the print server 101 for the file name field.

In step S803, the document data conversion unit 312 generates intermediate data from the document data temporary file 316 after the file name field is replaced with the character string “File Name in Cloud Storage”. At this time, since the file name field in the document data temporary file 316 has already been replaced with the character string “File Name in Cloud Storage”, the character string “File Name in Cloud Storage” that has been already replaced is also output to the intermediate data.

In step S804, the document data conversion unit 312 deletes the document data temporary file 316. In step S805, the intermediate data transmission unit 315 transmits the generated intermediate data to the print server 101. The processing then exits the flowchart.

As described above, the document conversion server 102 replaces the file name field of the temporarily stored document data with the character string of the file name in the cloud storage 103, and then converts the document data into intermediate data. Even if the file name in the cloud storage 103 includes a system-dependent character that cannot be used in the print server 101 or the document conversion server 102, the document conversion server 102 can thereby output the file name in the cloud storage 103 to the position of the file name field.

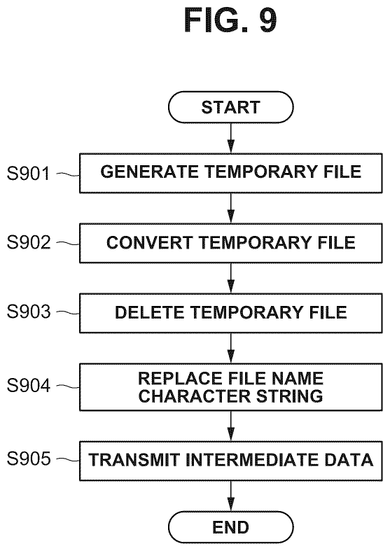

A third exemplary embodiment will now be described centering only on differences from the first exemplary embodiment. FIG. 9 is a flowchart illustrating detailed processing for generating intermediate data based on the document data in step S604 in FIG. 6 according to the third exemplary embodiment.

In step S901, the document data reception unit 311 of the document conversion server 102 stores the document data received from the print server 101, as the document data temporary file 316. At this time, the file name attached by the print server 101 is directly used as the file name of the document data temporary file 316. Alternatively, a file name suitable for the management in the document conversion server 102 is newly attached to the relevant file.

In step S902, the document data conversion unit 312 of the document conversion server 102 generates temporary intermediate data based on the document data temporary file 316. In step S903, the document data conversion unit 312 deletes the document data temporary file 316.

In step S904, the intermediate data editing unit 314 searches for the character string conforming to the file name of the document data temporary file 316 in the temporary intermediate data, deletes the character string, and instead, inserts the character string “File Name in Cloud Storage” received from the print server 101 to replace the original character string. In step S905, the intermediate data transmission unit 315 transmits the final intermediate data with which the file name field has been replaced with the character string “File Name in Cloud Storage” to the print server 101. The processing then exits the flowchart.

As described above, the document conversion server 102 generates intermediate data based on the document data file generated under a temporary file name, and replaces the character string conforming to the temporary file name in the intermediate data with the character string of the file name in the cloud storage 103. Even if the file name in the cloud storage 103 includes a system-dependent character that cannot be used in the print server 101 or the document conversion server 102, the document conversion server 102 can thereby output the file name in the cloud storage 103 to the position of the file name field.

The first to the third exemplary embodiments have been described above centering on a case where the print server 101 and the document conversion server 102 are separate server apparatuses. However, the present disclosure is not limited thereto. For example, the function of the print server 101 and the function of the document conversion server 102 may also be implemented on the same single server apparatus. Further, the function of the print server 101 and the function of the document conversion server 102 may also be implemented on a cloud server.

Embodiments of the present disclosure can also be achieved when a program for implementing at least one of the functions according to the above-described exemplary embodiments is supplied to a system or apparatus via a network or storage medium, and at least one processor in the computer of the system or apparatus reads and executes the program. A computer-readable storage medium for providing the system or apparatus with the above-described program is also included in the exemplary embodiments of the present disclosure. Embodiments of the present disclosure can also be achieved by a circuit, such as an application specific integrated circuit (ASIC), for implementing at least one of the functions of the above-described exemplary embodiments.

While the present disclosure includes the above-described preferred exemplary embodiments, the present disclosure is not limited thereto and can be modified and changed in diverse ways within the scope of the present disclosure.

According to the printing system of embodiments of the present disclosure, document data acquired from a storage is managed being attached with a file name different from the file name in the storage. The printing system makes it possible to generate print data such that a file name based on the file name in the storage is to be output to the file name field in the document data.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-202364, filed Nov. 30, 2023, which is hereby incorporated by reference herein in its entirety.

What is claimed is:

1. A printing system for acquiring document data stored in a storage and generating print data of the acquired document data, wherein the printing system comprises:
one or more processors; and
at least one memory storing executable instructions, which when executed by the one or more processors, cause the printing system to perform:
attaching a file name different from a file name in the storage to the document data acquired from the storage and storing the document data in a storage unit of the printing system;
generating, in a case where the document data includes a file name field where a file name is to be output, when generating intermediate data based on the document data stored in the storage unit, the intermediate data in a state such that a file name based on the file name in the storage is to be output to the file name field; and
generating print data print-executable with a printer by using the generated intermediate data.

2. The printing system according to claim 1, wherein the intermediate data is generated from the document data temporarily stored in a state in which a file name based on the file name in the storage is attached.

3. The printing system according to claim 1, wherein the intermediate data is generated based on document data after the file name field of the document data stored in the storage unit is replaced with a character string of the file name in the storage.

4. The printing system according to claim 1, wherein the intermediate data is generated based on temporarily stored document data after the file name field of the document data stored in the storage unit is replaced with a character string of the file name in the storage.

5. The printing system according to claim 1, wherein temporary intermediate data is generated based on document data stored in the storage unit, a character string corresponding to the file name field included in the temporary intermediate data is replaced with a character string of the file name in the storage, and the final intermediate data after the replacement is generated as the intermediate data.

6. The printing system according to claim 1, wherein the instructions, when executed by the one or more processors, further cause the printing system to perform:
receiving a request from a client terminal, and
wherein the document data acquired from the storage is document data specified by the request received from the client terminal.

7. The printing system according to claim 1, wherein the instructions, when executed by the one or more processors, further cause the printing system to perform transmitting the generated print data to the printer.

8. The printing system according to claim 1,
wherein the printing system comprises a print server and a document conversion server,
wherein the print server attaches a file name different from the file name in the storage to the document data acquired from the storage and stores the document data in the storage unit of the printing system,
wherein, in the case where the document data includes the file name field where the file name is to be output, when generating intermediate data based on the document data stored in the storage unit, the document conversion server generates the intermediate data in the state such that the file name based on the file name in the storage is to be output to the file name field, and
wherein the print server generates print data print-executable with the printer by using the generated intermediate data.

9. A non-transitory storage medium storing one or more computer programs for executing a control method for a document conversion server capable of communicating with a print server for acquiring document data stored in a storage and generating print data of the acquired document data, wherein the one or more computer programs include instructions, which when executed by one or more processors, cause the one or more processors to perform the control method comprising:
in a case where the document data includes a file name field where a file name is to be output, when generating intermediate data based on the document data, generating the intermediate data in a state such that a file name based on the file name in the storage is to be output to the file name field.

10. A method executed by a printing system for acquiring document data stored in a storage and generating print data of the acquired document data, the method comprising:
attaching a file name different from a file name in the storage to the document data acquired from the storage and storing the document data in a storage unit of the printing system;
generating, in a case where the document data includes a file name field where a file name is to be output, when generating intermediate data based on the document data stored in the storage unit, the intermediate data such that a file name based on the file name in the storage is to be output to the file name field; and
generating print data print-executable with a printer by using the generated intermediate data.
